(19) United States
(12) Patent Application Publication
(10) Pub. No.: US 2002/0133567 A1
(43) Pub. Date: Sep. 19, 2002

(54) Method and system for generalized common gateway interface processing

(76) Inventor: George A. Te, New Hamburg, NY (US)

Correspondence Address: Connolly, Bove, Lodge & Hutz, Suite 800, 1990 M Street, N.W., Washington, DC, 20036-3425, US

(21) Appl. No.: 09/758,980

(22) Filed: Jan. 12, 2001

(51) Int. Cl. G06F 15/16; G06F 15/163

(52) U.S. Cl. 709/219; 709/311

(57) ABSTRACT

Common Gateway Interface (CGI) processing is performed on networks such as the Internet, or Web, to allow users to enter input data, via CGI forms presented as Web pages by a browser, for processing by a network server. Existing CGI processing methods entail form-specific handling programs for each distinct CGI form, which typically number in the thousands. The present invention simplifies and streamlines CGI processing by providing a single, generalized CGI processing routine for a plurality of distinct CGI forms.

### BACKGROUND OF THE INVENTION

The present invention relates to a method and system for Common Gateway Interface (CGI) processing, and more particularly to a single, generalized process for handling a plurality of distinct CGI forms.

The interconnected network of source systems and networks spanning the globe, commonly known as the Internet (the terms “Internet” and “Web” are often used interchangeably), has seen a remarkable growth in applications in recent years. Software for accessing Internet services, commonly known as Web “browsers,” has enjoyed widespread sale and usage. The recent emergence of Web-based (commercial and non-commercial) applications hinged on widespread use of CGI to make the Internet interactive, receiving information (requests) from users, and responding back to the users.

Browsers interact over the Internet with network “servers” to perform CGI processing. A network server is a computer which perform services. CGI is a protocol in which a user using a Web browser may interact with the server, by submitting a request or data input for processing by the server. In addition to CGI processing, common services include name resolution and packet routing.

The Internet is populated with server nodes which respond to user requests for CGI processing, for example, by retrieving and displaying Web “pages” to users. A Web page is presented to the user, typically as a formatted display on a display device, by the Web browser.

Many Internet applications provide for users to enter input data to Web pages for processing by a server. A user performs operations with an input device such as a keyboard and/or mouse to interact with a Web page displayed on a display device. A user would, for example, use a mouse to “click” on (select) a particular display field such as a highlighted keyword on a Web page, to initiate a request for a CGI service from a server. In response to the request, the server would perform CGI processing to present a Web page to the user. The Web page would have formatted fields allowing for the user to enter data and send it to the server for processing.

Web pages typically contain regular text words and pictures, as well as “hyperlinked” words and pictures. For example, a “home” page is the first page in an Internet system. When a user enters the URL (Uniform Resource Locator) of an Internet application system, the first page that is sent by the server is usually the home page. The home page identifies the application and links and hyperlinks to other subsequent web pages.

A hyperlinked document is a document pointed-to in a Web page which has to be obtained from a source system. When a user clicks on a name (or word) associated with a hyperlinked document, the Web browser follows a path indicated in HTML (Hypertext Markup Language) code to obtain the document from the source system, bringing it back to present to the user. It is through the power of hyperlinking that a home page in the Internet system expands its reach, linking up a multitude of other source systems, bringing the vast resources of information back to a user's desk-top or fingertips.

Clicking on the hyperlinked words or pictures sends a request back to a server to serve up the requested/associated next web document, following the hyperlinked path. A hyperlink is also typically used in invoking a CGI program in the server.

The server typically executes CGI programs interactively with users. The server receiving CGI input submitted, for example, through input fields of a Web page, will invoke an associated CGI program to process the input. The CGI program usually sends a response back to the requester to signal the completion of the transaction.

CGI programs typically utilize CGI “forms.” It is typically a CGI form which determines how a Web page appears when it is displayed by a browser to a user. A CGI form has the “FORM” HTML structure, commands, syntax, and protocols. HTML is a well-known coding language with agreed-upon notations. An HTML notated document can traverse the Internet and present itself in any workstation with any variety of Web browsers. The notations deals with font, color, size, placement of elements within a document, as well as hyperlinking to other documents from the current, as well as other, source systems.

An ACTION command is also associated with the CGI form, specifying the name of a CGI program to invoke in the server, when a user has “completed” the form, i.e., entered data into fields of the CGI form and submitted it over the network for processing by the server.

A problem with current CGI methods is that they are “unstructured”, permitting too many confusing ways of implementing CGI solutions. In CGI processing according to existing art, a programmer first writes a CGI form in HTML language. This blank CGI form would be presented directly to a Web user via a hyperlink, or, more commonly, imbedded in an “initial” CGI program and presented to the user via a hyperlink.

Each of these initial CGI programs and HTML forms requires a corresponding ACTION program. The programmer next writes these ACTION programs, which are invoked by the Web server when a user submits a completed CGI form. The ACTION program tells the server what to do with the values or information submitted by the user.

In a typical system, therefore, as many pairs of initial/action CGI programs are needed as there are different or distinct forms. Such distinct forms can number in the thousands, each requiring its own specific initial/action CGI handling program pair.

A review of CGI usage in the Internet at large indicates that as many as 80% of all CGI applications follow a common predictable and necessary pattern. This common pattern is:

1. Prompting a user to complete (fill in) certain information in a CGI form.

2. Gathering of the user input from the submitted form.

3. Post-processing the input to generate further data.

4. Forwarding the input and data to targeted recipients

5. Responding back to the user.

Examples of CGI applications include:

a. Ordering a product. (e.g., on-line shopping/catalog).

b. Registering a name for a particular activity. (e.g., on-line subscription).

c. Requesting information from a source (e.g., on-line search, library).

d. Voting on a certain issue (e.g., on-line vote & tally).

e. Survey questionnaire (e.g., on-line survey & tally).

All the above CGI applications (a through e), which accounts for a very large class of Internet interactive usage, really fall into the same class of CGI implementation, all of which essentially employ steps 1 through 5, as listed above. For this reason, a generalized CGI handling process can be developed to consolidate all these diverse CGI applications, providing a common solution.

### SUMMARY OF THE INVENTION

A method and system according to the invention provide for generalized CGI processing which avoids the need for the thousands of form-specific handling programs which characterize existing CGI applications. Instead, a single, generalized CGI processing routine is used to handle a plurality of distinct CGI forms.

In an embodiment, the invention comprises a plurality of distinct CGI forms provided on a server in a network. The server receives a plurality of distinct user requests over the network, and responds to the requests by invoking a single, generalized CGI processing routine for enabling user data corresponding to the plurality of distinct CGI forms to be entered.

In the embodiment, an initial data-gathering routine of the generalized processing routine generates a parameter file from a selected CGI form corresponding to a user request, and presents the selected CGI form on a display device, to collect user input data corresponding to the selected CGI form. An action routine of the generalized processing routine reads the user input data based on the parameter file, and formats the user input data for output to the user. The action routine may execute post-processing functions to perform additional specified operations on the user input data, generate an output file with results of the operations, and transmit the output file as electronic mail (e-mail) to a targeted recipient.

### BRIEF DESCRIPTION OF THE DRAWINGS

FIG. 1 shows a portion of a network for implementing the method and system according to the invention;

FIG. 2 shows an example of a CGI form written in HTML;

FIG. 3 is a flowchart illustrating a process flow for an initial data-gathering program according to the invention;

FIG. 4 is a flowchart illustrating a process flow for an action program according to the invention;

FIG. 5 shows how the example form of FIG. 2 appears to a user when presented on a display device by a browser;

FIG. 6 shows an example of a user display corresponding to an acknowledgement or confirmation of completed CGI processing;

FIG. 7 shows an example of an e-mail display of an output file sent to a targeted recipient according to the invention; and

FIG. 8 shows examples of computer-usable media for storing computer-executable instructions according to the invention.

### DETAILED DESCRIPTION OF THE INVENTION

The present invention relates to networked computers, and computer-executable instructions for programming the computers to implement method steps of the invention. It is noted that program and file names described hereinafter are arbitrary and merely representative of functionality which could be implemented in a wide variety of computer instruction sequences invoked by arbitrarily-assigned mnemonics. Further, programming structures and functionality disclosed herein for performing method steps of the invention may find specific implementations in a variety of forms, which are considered to be within the abilities of a programmer of ordinary skill in the art after having reviewed the specification.

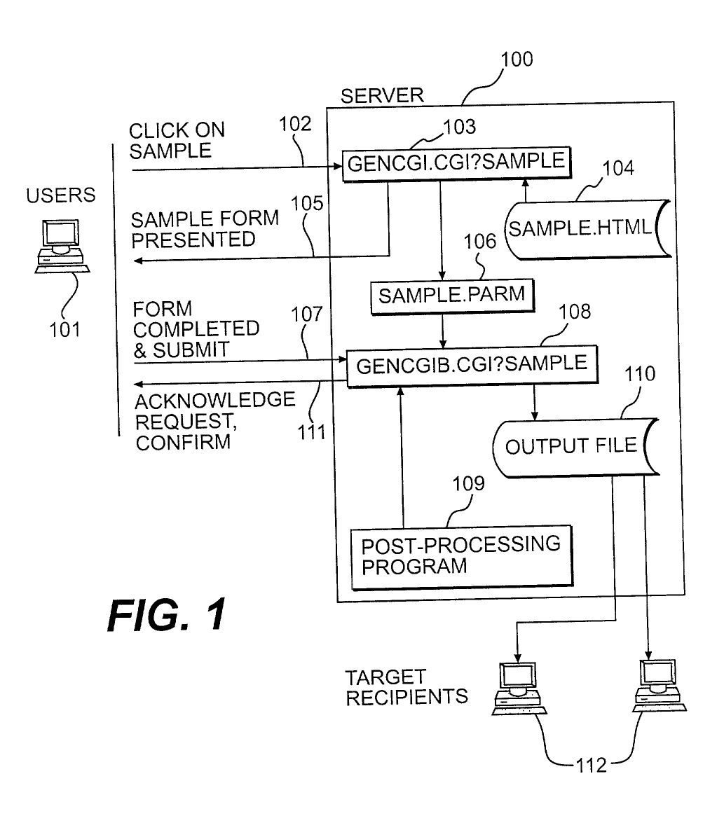

FIG. 1 illustrates representative components of a network including a server 100 connected via the network to a plurality of users 101 and a plurality of target recipients 112. The terms “users” and “target recipients” as employed herein refers to computers connected to a network such as the Internet, together with human operators running applications accessing the network. The applications may be generated with a browser; one common Internet browser is the Netscape® browser.

The server 100 comprises generalized CGI handling program code means according to the invention. The generalized CGI handling program code means includes an initial data-gathering program 103 (gencgi.cgi), and an action program 108 (gencgib.cgi). The character string following “?” appended to the program names gencgi.cgi and gencgib.cgi (“sample” in the example of FIG. 1) is passed as a parameter to the CGI handling process, and, among other things, denotes the name of a particular HTML form. The format shown is an arbitrary syntactical convention.

The CGI handling program is termed “generalized” because it constitutes a single or unique program for handling a plurality of different or distinct CGI forms, eliminating the need for the thousands of form-specific CGI handling programs required in existing methodologies.

To use the invention, a user or plurality of users 101 would typically perform operations using an input device such as a keyboard and/or mouse to interact with a user interface, such as Web page, displayed on a display device. Referring to FIG. 1, a user would, for example, use a mouse to click on a particular display field such as a highlighted keyword on a Web page, to initiate a request for a CGI service from the server 100. In FIG. 1, reference number 102 indicates a user request invoking the CGI form “sample.”

In response, the initial data-gathering program 103 (gencgi.cgi) reads the parameter, “sample”, searches for and, if it exists, retrieves a blank or template CGI form 104 (sample.html) corresponding to the parameter from a server database. The initial data-gathering program processes the blank CGI form according to the invention to generate a parameter file 106 (sample.parm), and presents the blank form via the network to the user, typically as a display prompting the user for various inputs (reference number 105). The display will typically include a reply prompt, for example, “Submit”, for notifying the server that the user has finished entering inputs and that the completed form is ready for processing.

The user enters input data to complete the form, and enters the reply prompt to submit the completed form, as indicated by reference number 107. The data entered by the user into the form travels via the network back to the server 100.

At the server, the action program 108 (gencgib.cgi) processes the user data, reading the parameter file 106 to determine which fields of the completed form to collect data from.

For some CGI forms, the action program may simply format the collected data for output, and write it to an output file 110. For other CGI forms, additional operations on the data by a post-processing program 109 may be entailed before an output file 110 is generated.

As indicated by reference number 111, the action program sends an acknowledgement via the network back to the invoking user, confirming for the user that his or her request has been processed. The acknowledgement may include a repetition of the user's original input, plus additional results generated by the post-processing program 109.

The post-processing program, if one is included, performs operations on the user's input data. Such operations could include, for example, computations of cost totals for product orders, tax computations, vote tabulations, and the like. Results of the post-processing program may be written to an output file 110, and sent via the network to target recipients 112.

As noted above, the single generalized CGI handling program according to the invention processes a plurality of distinct or different CGI forms. Each form is embodied as a stand-alone HTML file stored on the server, in contrast to many existing CGI applications which “embed” the HTML form in the handling program itself.

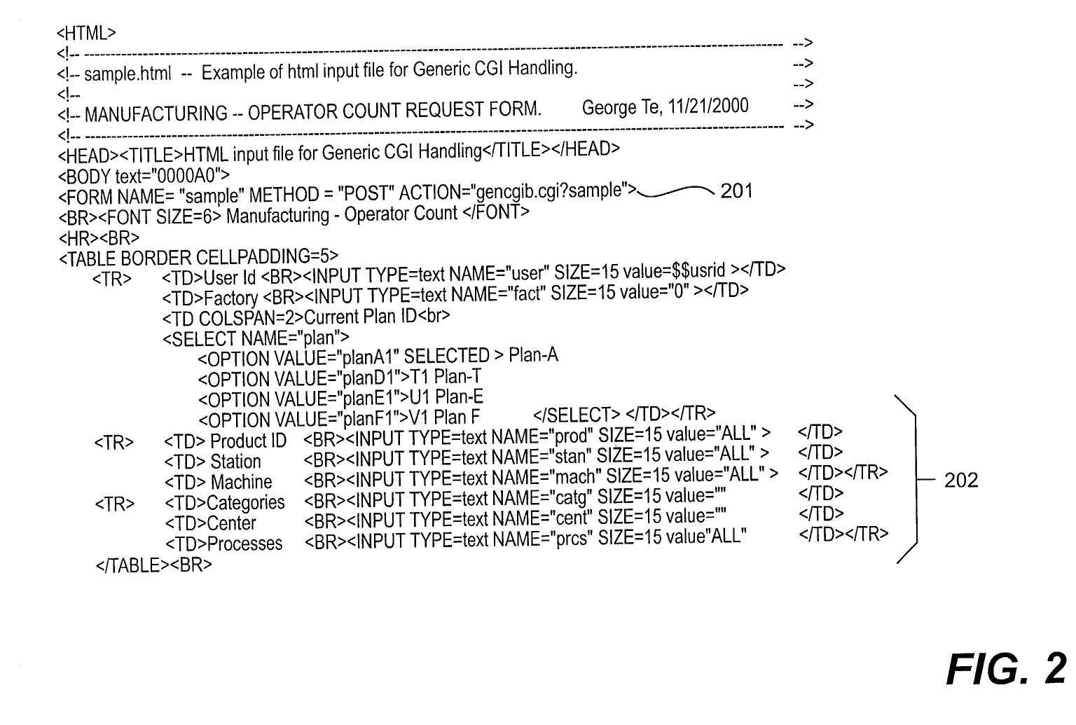

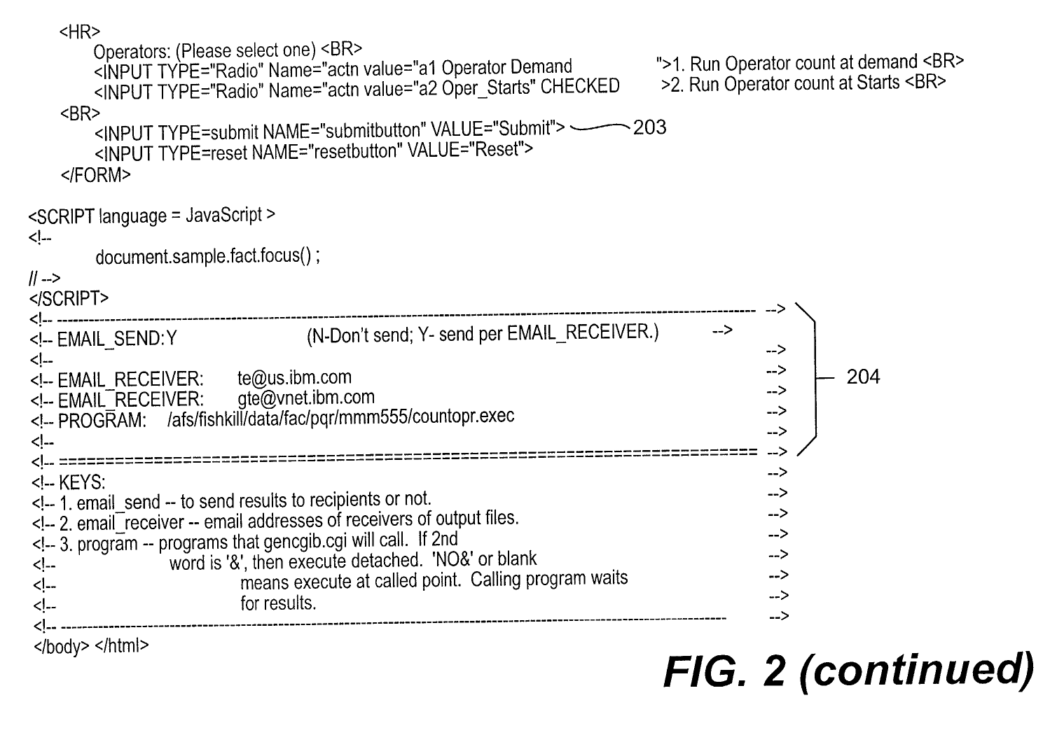

FIG. 2 shows an example of an HTML form such as might be processed by the generalized CGI handling program of the invention. The form includes a portion 201 setting forth a FORM statement 201 identifying the form name (“sample”, in this example) and an ACTION program statement identifying the action program, gencgib.cgi, which takes the form name, “sample”, as a parameter. The form further includes input fields 202, which, when presented by the initial data-gathering program gencgi.cgi to a user, would correspond to display fields on a display device allowing for user input. Types of input fields would depend upon the particular CGI application. The example of FIG. 2 corresponds to a manufacturing/operator count application, and thus the input fields prompt the user for information such as “Product ID”, “Station”, “Machine” and the like.

The form further includes a reply prompt field 203 (“submitbutton”) for allowing the user to signal the server that data has been entered in the form, and that the form is to be processed. Also included is a non-displayed section 204 for specifying an e-mail address for target recipients of an output file, and for specifying the name of a post-processing program.

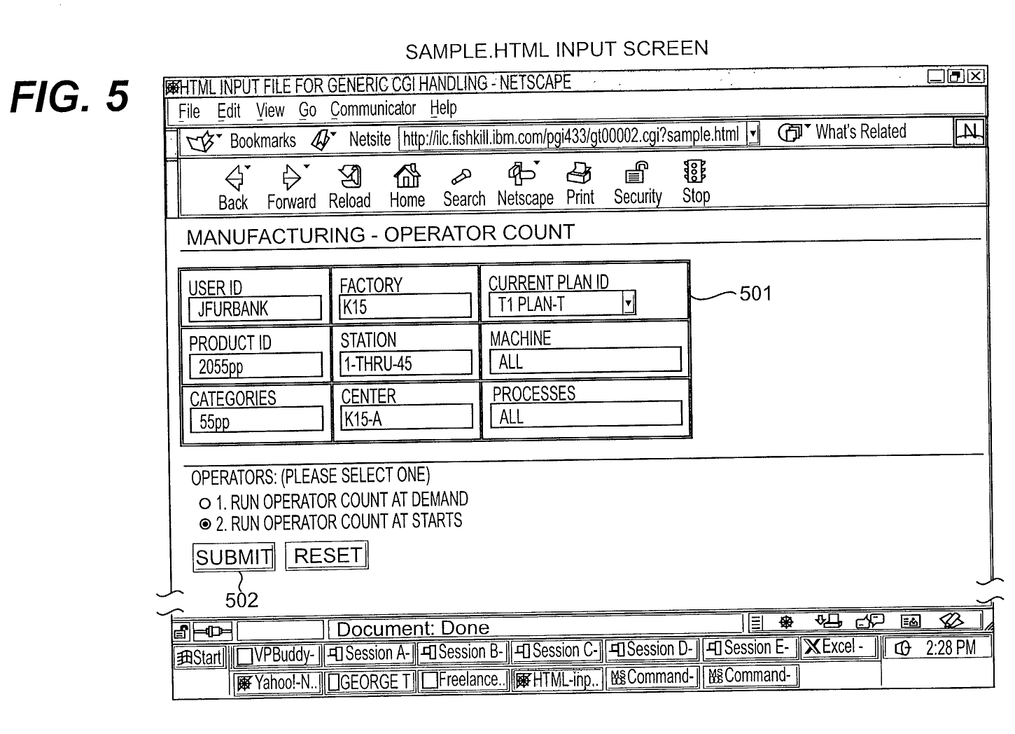

FIG. 5 shows an example of a Web page screen display by a browser, corresponding to the HTML file of FIG. 2. The display includes an input field section 501, including user-input values.

Ref. no. 502 indicates a “submit” button, which the user can click to sent the completed CGI form to the server.

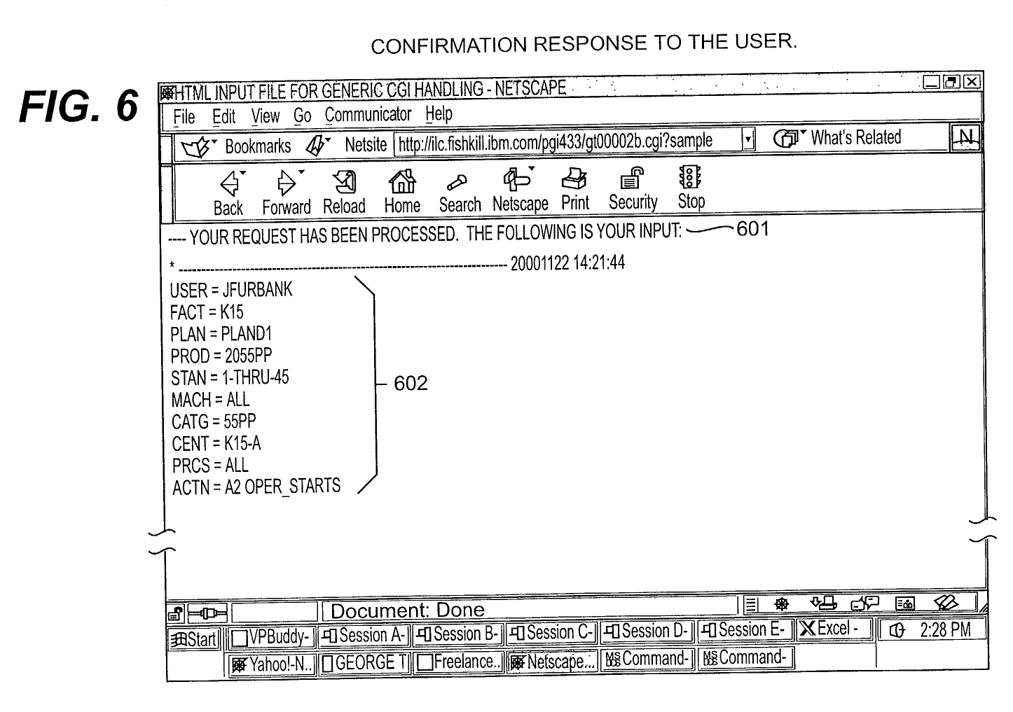

FIG. 6 shows another example of a Web page screen display, corresponding to an acknowledgment or confirmation 601 from the action program to the user that the user's request has been processed. In FIG. 6, the user's original input 602, as shown in FIG. 5, is “echoed” or repeated.

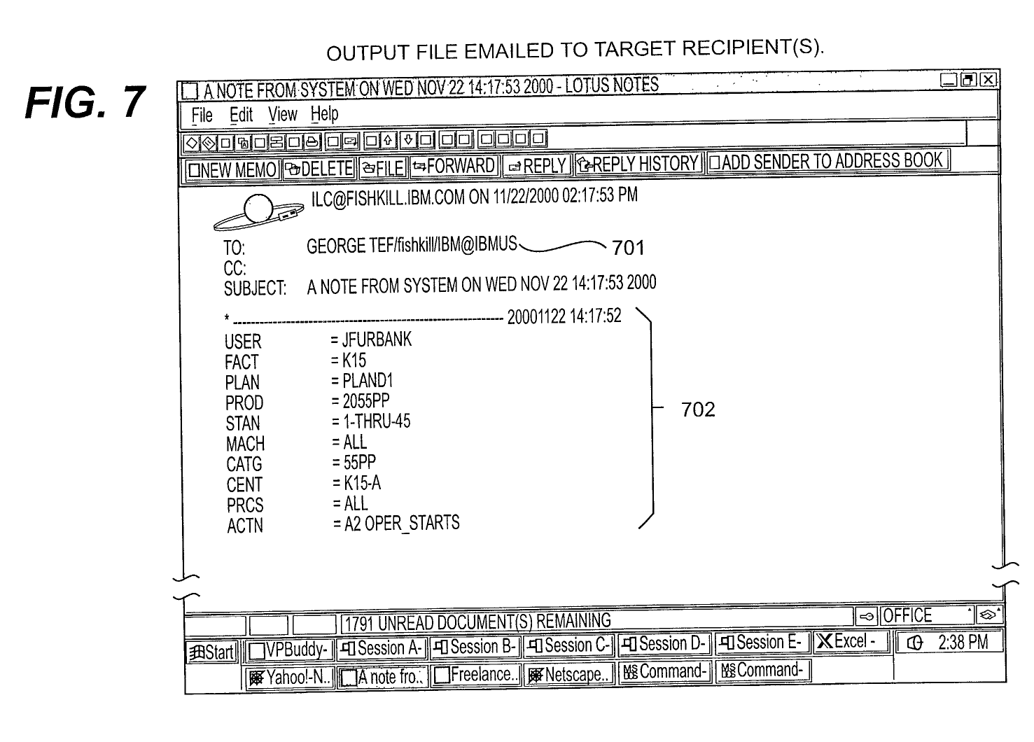

FIG. 7 shows an example of an e-mail display, corresponding to an output file 110 e-mailed to a target recipient. Examples of output files include orders, subscriptions, registrations, vote tallies and the like. In FIG. 7, a target recipient e-mail address 701 and e-mail contents 702 are shown. The information shown in e-mail contents 702 came from the input fields of the completed HTML form, as extracted by the action program 108, gencgib.cgi, using the parameter file 106. The output file may also include results of operations performed by a post-processing program 109.

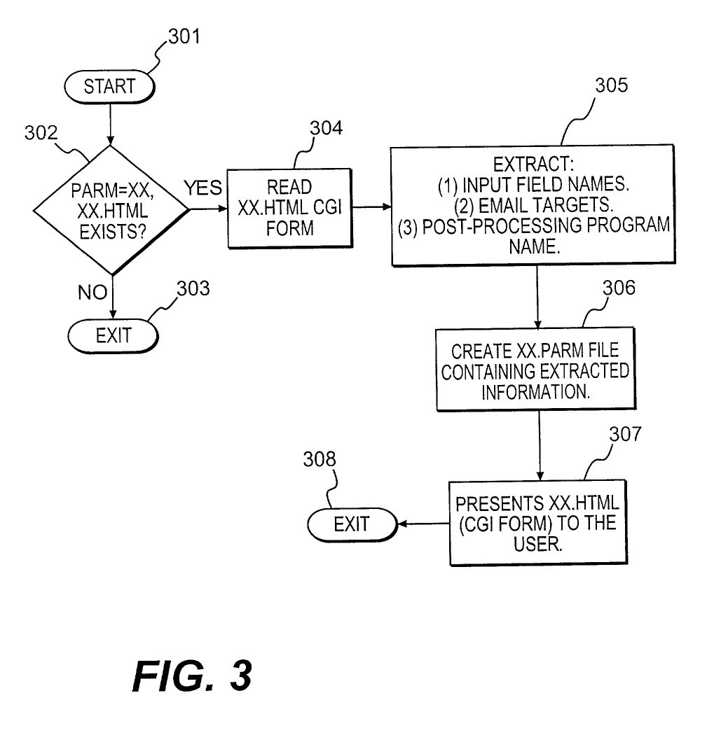

Referring now to FIG. 3, there is shown a processing flow for the initial data-gathering program 103, gencgi.cgi. As noted above, the initial data-gathering program may be invoked by a user by using input means for interacting with a user interface of a computer linked to a network. For example, the user may click on a highlighted keyword, such as “Sample here” in a Web page. An example of HTML code generating the highlighted keyword and responding to the user's request by clicking is: <A HREF=“/kwy2/xxx/gencgi.cgi?sample”> Sample here </A>. This code treats a character string following “?” as a parameter to be supplied to the gencgi.cgi program, and causes “Sample here” to be displayed by the browser as a prompt.

Upon user input by clicking or other means, a request is sent via the network to the server 100 invoking the initial data-gathering program gencgi.cgi (block 301). In block 302, the initial data-gathering program checks for the existence of an HTML form which corresponds to the parameter supplied, in order to present the form to the user. The initial data-gathering program would substitute whatever parameter was supplied for “xx”, and search for “xx.html” in, for example, a form database of the server. For example, if “sample” was requested as discussed in connection with FIG. 1, the initial data-gathering program would search for “sample.html”.

If gencgi.cgi does not find an HTML form corresponding to the user's request, it cannot service the request and so it exits, as shown in block 303. The gencgi.cgi program would typically reply to the user with a message that the requested file is not available.

If gencgi.cgi does find the appropriate HTML form, it reads the form into an internal array as shown in block 304. Then, as shown in block 305, gencgi.cgi extracts the input field names of the HTML form, the e-mail addresses of target recipients, if any, and the name of a post-processing program, if any. This step provides generality to the form processing by making it possible for the action program which is subsequently executed to be applied without having specific knowledge of a particular form. In existing CGI methods, by contrast, an action program is coded with specific knowledge of input field names of the corresponding form, which is needed to unpack a user-posted data stream; therefore its applicability is restricted to that form.

The gencgi.cgi program creates a parameter file (“sample.parm”, for example) containing the extracted information, as shown in block 306. Then, via the network, the gencgi.cgi program reads out the array containing the HTML form lines, to present the form as a display allowing inputs by a user as described above. The gencgi.cgi program then exits, as shown in blocks 307 and 308.

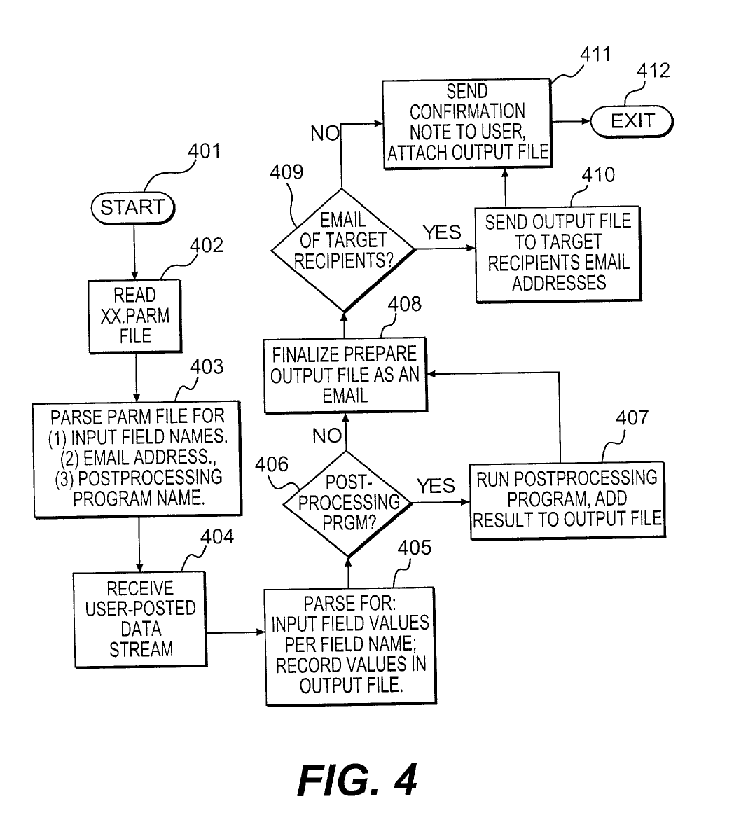

As shown in FIG. 4, when the user completes the form and submits it back to the server, generating a user-posted data stream, the server invokes the action program specified in the ACTION command, in this case gencgib.cgi. Start block 401 represents the initiation of processing by the action program. The action program reads the parameter supplied (e.g “sample”), and reads the corresponding parameter file xx.parm (e.g., “sample.parm”) generated by the initial data-gathering program, as shown in block 402. As shown in block 403, the action program then parses the parameter file for input field names, and e-mail address and post-processing program name, if any.

As shown in block 404, the action program then receives the user-posted data stream corresponding to the “xx.html” file completed and submitted by the user. The data stream contains user-input values corresponding to input fields in the original CGI form. The action program uses the “xx.parm” file created by the initial data-gathering program to parse the data stream for input field values per field name, and records the values in an output file, as shown in block 405. By using the parameter file as described, the action program has general applicability to a plurality of distinct forms, since it does not need specific knowledge of the input field names of the forms.

The action program checks for whether a post-processing program name has been included, as shown in block 406. If a post-processing program has been specified, the action program causes it to be executed, as shown in block 407, and then proceeds to block 408. If a post-processing program has not been specified, the action program simply proceeds to block 408.

In block 408, the action program formats input data read from the user-posted data stream, and data resulting from any post-processing program, to finalize and prepare an output file as an e-mail, and possibly to attach to an acknowledgement/confirmation to the requesting user.

In block 409, the action program checks for the existence of an e-mail address or addresses of a target recipient or recipients. If an e-mail address has been specified, the action program sends the output file to the target recipient as shown in block 410, and sends a confirmation to the user, possibly including the output file, as shown in block 411. If an e-mail address has not been specified, the action program proceeds to block 411 and sends a confirmation to the user, possibly including the output file. The action program then exits as shown in block 412.

To implement the generalized CGI handling program according to the invention, a programmer would typically first create the CGI form file for the desired application, following “form” HTML rules and syntax. The form usually includes various input fields and names, including checkboxes and radio-buttons. At the end of the form a “Submit” button is usually provided.

As noted above, specific implementations may utilize a hyperlink to invoke CGI processing according to the invention, with the name of the specific CGI form passed as a parameter. Within a Web page, the HTML notation for hyperlinking is “A HREF”, designating that what follows is a hyperlinked document.,

For example, the following HTML code would invoke the generalized CGI handler via a hyperlink:

| | |
|---|---|
| < A HREF=“gencgi.cgi?sample”> | Sample here </A> or |
| < A HREF=“gencgi.cgi?order”> | Order here </A> |
| < A HREF=“gencgi.cgi?vote”> | Vote here >/A> |

Each of the above three lines invokes the same generalized CGI initial data-gathering program, “gengci.cgi”, while passing the program a specific CGI form name as a parameter (“?” indicates “parameter to follow”). The different parameters are “sample”, “order” and “vote”, respectively, each invoking a different CGI form, but the program name remains the same, “gencgi.cgi”.

As described above, the user would typically next fill in the information requested by the CGI form, then hit “submit”. The submit command sends the completed CGI form from the Web browser to the server, invoking “gencgib.cgi”, the ACTION program. “Gencgib.cgi” is specified in the action command in the CGI form HTML file. An example HTML statement specifying the action program is: <FORM NAME=“sample” METHOD=“POST” ACTION=“gencgib.cgi?sample”>. On a “submit”, the server invokes “gencgib.cgi” to process the submitted CGI form.

Examples of two specific applications follow. In each application, the same generalized CGI handling program is used.

### EXAMPLE A

### Ordering from an Online Catalog

1. A user using a Netscape browser clicks and navigates to A_COMPANY catalog. After browsing for merchandise, the user clicks on “Order”.

2. The hyperlink address is “gencgi.cgi?order”, which invokes the “gencgi.cgi” program, passing the parameter “order”. Gencgi.cgi reads and presents “order.html” to the user's Web screen. “Order.html” is a CGI form with input fields and a submit button. Gencgi.cgi also generates a parameter file containing the “order” input field names, as well as: (1) e-mail addresses of target recipients; and (2) a post-processing program name.

3. The user completes the order.html form and hits submit.

4. The submitted CGI form invokes “gencgib.cgi” at the server. Gencgib.cgi reads order.parm (as generated by the preceeding gencgi.cgi program). Gencgib.cgi strips and formats the user's posted order data stream, which has just arrived at the server. Next, it calls the post-processing program which adds up the order, calculates taxes and shipping charges, puts all this information in an order output file, and e-mails the output file to the target recipient(s). It also sends an acknowledgement note back to the user, letting him/her know that the request has been processed. The output file can also be attached to the acknowledgement showing the transaction details.

5. The target recipient, in this case, an order fulfillment clerk, receives the order as an e-mail (=the output file), and can further forward the e-mail to the next department, possibly the billing department.

### EXAMPLE B

### Voting Online on an Issue

1. A user uses a Netscape browser as in EXAMPLE A.

2. The hyperlink address is “genegi.cgi?vote2”, which invokes “gencgi.cgi”, passing the parameter “vote2”. Same as in Example A.

3. The user completes the vote2.html form and hits submit.

4. The submitted CGI form invokes “gencgib.cgi” at the server which reads vote2.parm (as generated by the proceeding gencgi.cgi program). As in Example A, if a post-processing program is provided, it will be invoked at this point. Possibly such a program adds the vote to an ongoing tally, generating a new bar chart each time. An output file containing the new tally, plus the new bar chart would be generated by “gencgib.cgi”, and (a) forwarded to e-mail addresses of target recipient(s); and (b) sent back as a response to the user. The user sees the response in his/her Web browser screen.

5. The target recipients, in this case, perhaps election board members, would receive the output file, which has the new tally and a new bar chart.

As can be seen by the above two examples, gencgi.cgi and gencgib.cgi are generalized and common across various CGI applications. For each new implementation, the only pieces that needed to be developed are (1) the CGI form HTML file, and (2) the post-processing program, if any, tailored to an application. In many simpler CGI implementations, where no post-processing is involved, the work is reduced to that of creating the unique CGI form HTML file.

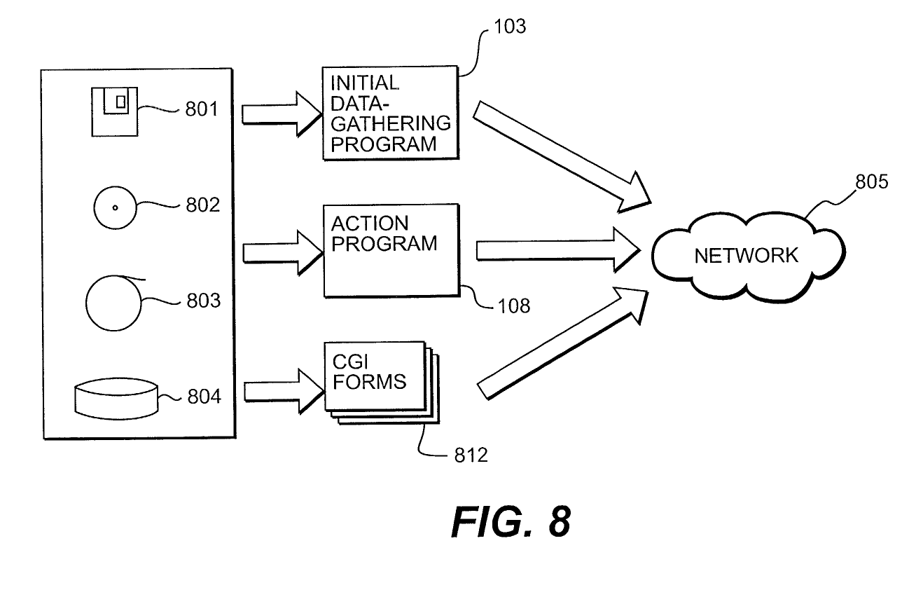

As shown in FIG. 8, a computer program or collection of programs including an initial data-gathering program 103, an action program 108 and a plurality of CGI forms 812 comprising computer-executable instructions for performing method steps according to the present invention may be stored and transported on computer-usable media such as diskette 801, CD-ROM 802, magnetic tape 803 and fixed disk 804. To perform steps of the method, computer instructions according to the present invention may be retrieved from the computer-usable media 801-804 using a suitable drive device and executed by a processor or processors in a network server in a network 805. Data generated according to the invention may travel over a network medium in the form of electronic signals to network users. The users may in turn generate data as determined by forms presented by the invention, and the user-generated data will travel across a network medium in the form of electronic signals to processed at a network server.

The foregoing description of the invention illustrates and describes the present invention. Additionally, the disclosure shows and describes only the preferred embodiments of the invention, but it is to be understood that the invention is capable of use in various other combinations, modifications, and environments and is capable of changes or modifications within the scope of the inventive concept as expressed herein, commensurate with the above teachings, and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A method for generalized Common Gateway Interface (CGI) processing, comprising:
(a) providing a plurality of distinct CGI forms on a server connected to a network;
(b) receiving a plurality of distinct user requests over said network; and
(c) responding to said requests by invoking a single, generalized CGI processing routine for enabling user data corresponding to said plurality of distinct CGI forms to be entered.

2. The method of claim 1, said step (c) comprising:
(d) generating a parameter file from a selected CGI form corresponding to a user request; and
(e) presenting said selected CGI form on a display device, to collect user input data corresponding to said selected CGI form.

3. The method of claim 2, said step (d) comprising extracting input field names from said selected CGI form.

4. The method of claim 2, further comprising:
reading said user input data based on said parameter file; and
formatting said user input data for output to said user.

5. The method of claim 4, further comprising:
executing post-processing functions to perform additional specified operations on said user input data;
generating an output file including formatted input data and results of said operations; and
reporting a result of said request back to said user.

6. The method of claim 5, wherein said post-processing functions include calculations based on said user input and dispatching electronic mail transmitting said output file to a targeted user.

7. A system comprising:
a network for transmitting a plurality of user requests to a server;
a server linked to said network, said server comprising:
a plurality of distinct CGI forms corresponding to said requests; and
generalized handling means for handling each of said plurality of distinct CGI forms in response to said requests.

8. The system of claim 7, said generalized handling means comprising single initial data-gathering means for generating a plurality of distinct parameter files from said plurality of distinct CGI forms.

9. The system of claim 8, said generalized handling means further comprising single action means for processing said parameter files and performing user-specified operations corresponding thereto.

10. The system of claim 9, said initial data-gathering means further comprising:
means for retrieving said distinct CGI forms from said server in response to said requests; and
means for presenting said distinct CGI forms to a user and accepting corresponding user input data.

11. The system of claim 10, said action means further comprising:
means for reading said user input data based on said parameter files;
means for formatting said user input data;
means for calling post-processing functions to perform additional specified operations on said user input data;
means for generating an output file including formatted input data and results of said operations; and
means for reporting a result of a request back to a user.

12. The system of claim 11, wherein said post-processing functions include calculations based on said user input and dispatching electronic mail transmitting said output file to a targeted user.

13. In a network linking issuers of requests to a server comprising a plurality of distinct CGI forms, a method comprising:
(a) in response to a first request, retrieving a first CGI form from said server and presenting said first CGI form to an issuer of said first request;
(b) accepting first input data based on said first CGI form and sending said first input data to said server;
(c) in response to a second request, retrieving a second CGI form different from said first CGI form from said server, and presenting said second CGI form to an issuer of said second request;
(d) accepting second input data based on said second CGI form and sending said second input data to said server; and
(e) using a single CGI form handling program of said server for processing both said first and second CGI forms and first and second input data.

14. The method of claim 13, said step (e) comprising:
executing the same initial data gathering routine for each of said first and second requests, said initial data gathering routine comprising the steps of:
parsing input fields in the corresponding CGI form to generate a parameter file;
displaying the corresponding CGI form on a display device; and
generating a submitted CGI form by recording inputs to said corresponding CGI form via said display device.

15. The method of claim 14, said step (e) further comprising:
following said initial data gathering routine, executing the same data processing routine for each of said first and second requests, said data processing routine comprising the steps of:
(f) reading said parameter file to determine which fields of said submitted CGI form to process;
(g) formatting data in fields determined according to step (f); and
(h) returning a result of said request to an issuer of said request.

16. The method of claim 15, further comprising:
executing a post-processing program, said post-processing program performing operations on said inputs; and
sending an output file generated by said post-processing program to an electronic mail address of a target recipient.

17. A computer program product tangibly embodied on a computer-usable medium, said computer program product comprising computer-executable instructions which when executed implement a process comprising:
(a) providing a plurality of distinct CGI forms on a server connected to a network;
(b) receiving a plurality of distinct user requests over said network; and
(c) responding to said requests by invoking a single, generalized CGI processing routine for enabling user data corresponding to said plurality of distinct CGI forms to be entered.

18. The program product of claim 17, said step (c) comprising:
(d) generating a parameter file from a selected CGI form corresponding to a user request; and
(e) presenting said selected CGI form on a display device, to collect user input data corresponding to said selected CGI form.

19. The program product of claim 18, further comprising:
executing post-processing functions to perform additional specified operations on said user input data;
generating an output file including formatted input data and results of said operations; and
reporting a result of said request back to said user.

20. The program product of claim 19, wherein said post-processing functions include calculations based on said user input and dispatching electronic mail transmitting said output file to a targeted user.
